(19) United States
(12) Patent Application Publication
(10) Pub. No.: US 2005/0063393 A1
(43) Pub. Date: Mar. 24, 2005

(54) Method of network address port translation and gateway using the same

(76) Inventor: Jyun-Naih Lin, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/811,214

(22) Filed: Mar. 26, 2004

(30) Foreign Application Priority Data
Sep. 19, 2003 (TW) 92125859

(51) Int. Cl. H04L 12/56

(52) U.S. Cl. 370/395.54; 370/395.52

(57) ABSTRACT

A method of network address port translation and look-up. In a network address port translation (NAPT) gateway connecting a virtual internal network and an external network, the virtual internal network includes at least a server, and the external network includes at least a host. When an incoming data packet of a data stream is received from the external network, not only are the destination internet protocol (IP) address and port therein translated, but also the source IP address or source port is replaced by an index of a translation data in a NAPT translation table corresponding to the data packet. When an outgoing data packet of the same data stream is received from the internal network, the index drawn from the destination IP address or destination port can be directly mapped to the translation data.

### BACKGROUND OF THE INVENTION

1. Field of the Invention

The present invention relates to a gateway, and in particular to a network address port translation (NAPT) gateway providing fast look-up and translation of network addresses and ports in virtual servers.

2. Description of the Related Art

FIG. 1 is a schematic diagram of a NAPT gateway. FIG. 2 is a schematic diagram of a method for translation in a conventional NAPT gateway, in which a virtual internal network contains servers 120 and 122 of which private (virtual) internet protocol (IP) addresses are S1 and S2 respectively. The external network comprises hosts 100, 102, and 104, public IP addresses of which are C1, C2 and C3 respectively. The hosts 100, 102, and 104 set up a connection to the NAPT gateway 110 device using ports CP1, CP2, and CP3. The public IP address of the NAPT gateway 110 is address G. The NAPT gateway 110 has a virtual server mapping table 112 recording GP1, SP1 corresponding to GP1, GP2, and SP2 corresponding to GP2.

When external host 100, 102, or 104 transports data packets to ports GP1 or GP2 of NAPT gateway 110, the NAPT gateway 110 performs NAPT, transports the data packets to port SP1 of the internal server 120 or port SP2 of the internal server 122, and records the translation data in NAPT table 114 for translation of returned outgoing data packets of the same connection from the internal servers.

The translation data recording port CP1 of host 100, port GP1 of NAPT gateway 110, and port SP1 of internal server 120 are recorded in the NAPT translation table 114, as shown in FIG. 2. The host 100 transports a data packet 130 to the NAPT gateway 110, which contains source IP address, source port, destination IP address and destination port. The source IP address and the source port are IP address C1 and port CP1 of the host 100. The destination IP address and port are IP address G and port GP1 of NAPT gateway 110, wherein the port GP1 corresponds to port SP1 of the server 120. When receiving data packet 130, the NAPT gateway 110 searches the translation data in the NAPT translation table 114 by hashing or linear searching. When the translation data is located, the data packet 130 is translated into data packet 132 destination IP address and port of which are IP address S1 and port SP1 of server 120.

In reverse direction, server 120 transports a data packet 134 to the external host 100. The data packet 134 contains source IP address S1, source port SP1, destination IP address C1 and destination port CP1. When receiving data packet 134, the NAPT gateway 110 also searches the translation data in the NAPT translation table 114 by hashing or linear searching. When the translation data is located, the data packet 134 is translated into data packet 136 source IP address and port of which are public IP address G and port GP1 of the NAPT gateway 110.

Linear search of the translation data in the NAPT translation table 114 is extremely time-consuming, and hashing can cause collision, in the event of which, rehashing or linear searching can solve the collision. Even so, if a hash function is not chosen properly, time spent on hashing will be as much as that spent on linear searching.

### SUMMARY OF THE INVENTION

Accordingly, an object of the invention is to provide a method of fast look-up and translation of network addresses and ports in a NAPT gateway. When a data packet is transported from an internal server to an external host through the NAPT gateway, the destination address or port information therein can be directly mapped to translation data corresponding to the data packet in the NAPT translation table without hashing or linear searching.

To achieve the foregoing object, the invention provides a method of fast look-up and translation of network address and port, performed in a gateway connecting a virtual internal network and an external network. The virtual internal network comprises at least a server, and the external network includes at least a host. First, a translation table is created, comprising a plurality of translation data entries each of which is provided with an index and comprises host address and port information, server address and port information, and gateway address and port information. The server address and port information further comprises internet protocol (IP) address information and port information. Next, a first data packet containing first source address and port information and first destination address and port information from the external host is received by the gateway. The first source address and port information comprises IP address information and port information. Corresponding translation data of the first data packet in the translation table is searched. The first source IP address or port information is translated into a factor related to the index of the translation data and the first destination address and port information are translated into the server IP address and port information of the corresponding translation data when the corresponding translation data of the first data packet is located. The first data packet is transported to a corresponding internal server according to the server IP address information therein.

In addition, a second data packet comprising second source address and port information and second destination address and port information from the internal server is received by the gateway. The second destination address and port information comprises second destination IP address and port information, one of which acts as a second factor related to a second index according to the system design. The related second index is acquired according to the second factor and corresponding translation data of the second data packet is got from the translation table according to the second index directly. Next, the second source address and port information are translated into gateway address and port information of the translation data, and the second destination IP address or port information are translated into host IP address or port information of the translation data. The second data packet is transported to a corresponding external host according to the IP address thereof.

In addition, the invention provides a network address port translation (NAPT) and fast look-up gateway connecting a virtual network and an external network, comprising a translation table, a receiving unit, a processing unit and a transporting unit. The translation table comprises a plurality of translation data entries each provided with an index and comprising host address and port information, server address and port information, and gateway address and port information. The server address and port information comprises internet protocol (IP) address and port information. The receiving unit receives, from the external host, a first data packet comprising first source address and port information and first destination address and port information. The first source address and port information comprises first IP address and port information. The processing unit searches corresponding translation data of the first data packet in the translation table and translates the first source IP address or port information into a factor related to the index of the translation data and the first destination address and port information into the internal server address and port information of the corresponding translation data when the corresponding translation data of the first data packet is located. The transporting unit is coupled with the processing unit and transports the first data packet to a corresponding server according to the server IP address therein.

In addition, the receiving unit receives, from the internal server, a second data packet containing second source address and port information and second destination address and port information. The second destination address and port information contains second IP address and port information, one of which acts as a second factor related to a second index according to the system design. The processing unit acquires the related second index according to the second factor, retrieves corresponding translation data of the second data packet from the translation table according to the second index directly and translates the second source address and port information into gateway address and port information of the translation data and the second destination IP address or port information into host IP address or port information of the translation data according to the system design. Finally, the transporting unit transports the second data packet to a corresponding external host according to the IP address of the corresponding host.

### BRIEF DESCRIPTION OF THE DRAWINGS

The present invention can be more fully understood by reading the subsequent detailed description and examples with references made to the accompanying drawings, wherein:

FIG. 1 is a schematic diagram of a conventional NAPT gateway.

FIG. 2 is a schematic diagram of the NAPT method for a conventional NAPT gateway.

FIG. 3 is a structural diagram of the NAPT gateway according to the first embodiment of the present invention.

FIG. 4 is a schematic diagram of the method of network address port translation and fast look-up in the first embodiment of the invention.

FIG. 5 is the structural diagram of the NAPT gateway of the second embodiment of the invention.

FIG. 6 is a schematic diagram of the method of network address port translation and fast look-up in the second embodiment of the invention.

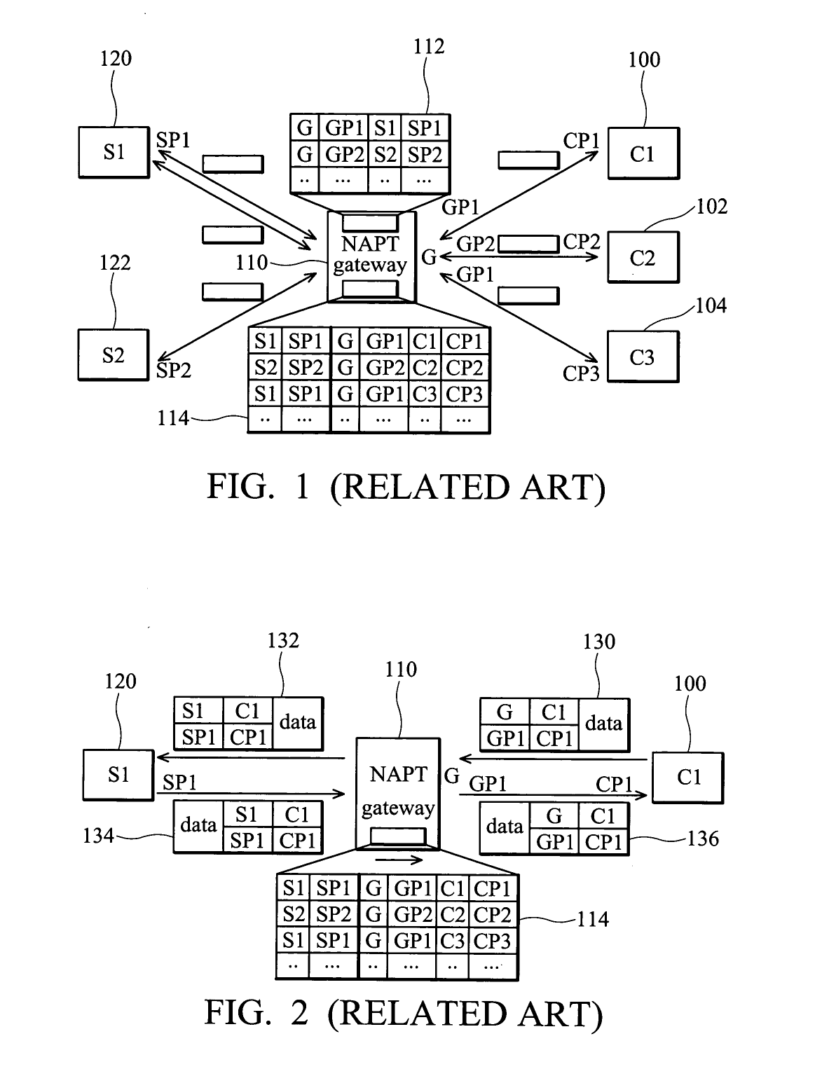

### DETAILED DESCRIPTION OF THE INVENTION

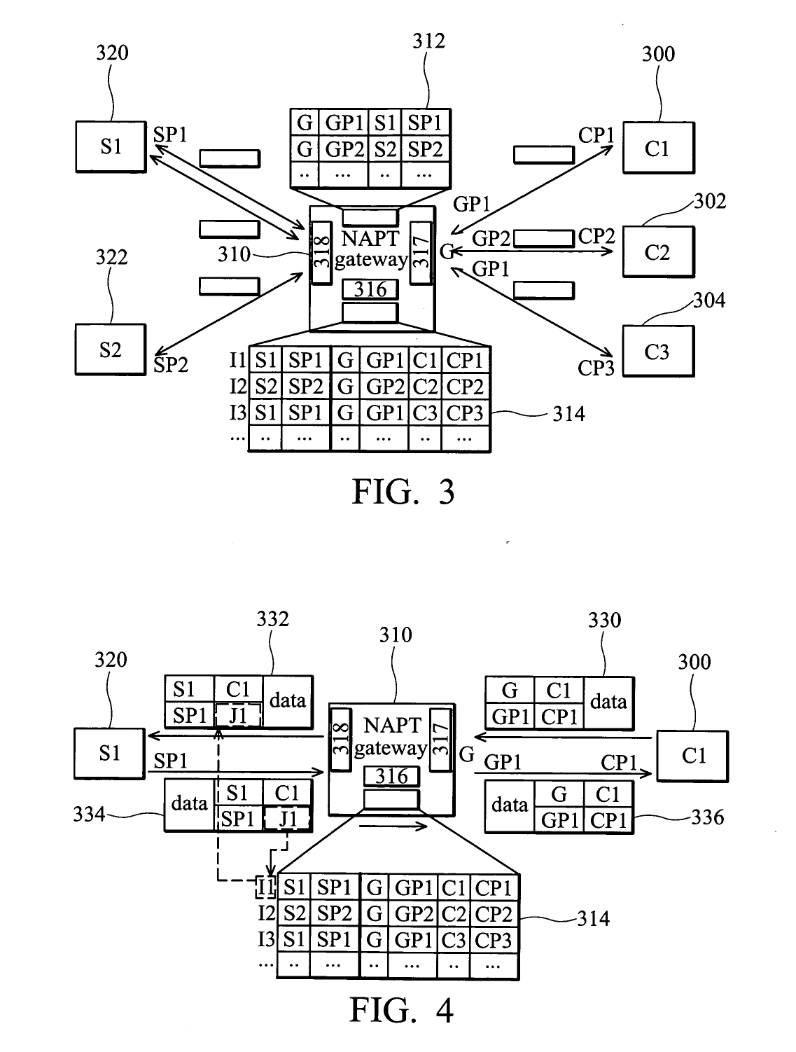

As summarized above, the present invention provides a method of fast look-up and translation of network address and port performed in a NAPT gateway. FIG. 3 is a structural diagram of the NAPT gateway according to the first embodiment of the present invention.

The NAPT gateway 310 connects a virtual internal network and an external network. In this embodiment, the virtual internal network containing server 320 and 322 private IP addresses of which are S1 and S2 and providing service on port SP1 and SP2 respectively. As well, the external network contains hosts 300, 302, and 304 legal public IP addresses of which are C1, C2 and C3 and connecting to a NAPT gateway 310 device using port CP1, CP2, and CP3 respectively. The NAPT gateway 310 is provided with a legal public address G, and comprises a virtual server mapping table 312. The virtual server mapping table 312 stores a plurality of mapping data entries each comprising server address and port information containing a private IP address and port information of a server and corresponding gateway address and port information containing a gateway IP address and gateway port information, wherein gateway IP address is a public IP address of the gateway 310, and gateway port information is a corresponding port of the port of the server where service is provided. In this embodiment, two sets of mapping data are stored in virtual server mapping table 312: [G, GP1, S1, SP1] and [G, GP2, S2, SP2], representing that port GP1 and GP2 of NAPT gateway 310 mapped to port SP1 of server 320 and port SP2 of server 322.

As well, a NAPT translation table 314 is maintained in NAPT gateway 310. NAPT gateway 310 provides each set of translation data with an index. Each set of translation data comprises host address and port information, server address and port information, and gateway address and port information, wherein host address and port information comprises a host IP address and host port information, server address and port information comprises private server IP address and port information, and gateway address and port information comprises gateway IP address and gateway port information. The gateway IP address comprises the legal public address of the NAPT gateway, and the gateway port information comprises a port number of the NAPT gateway corresponding to the port of a server where service is provided. The NAPT gateway 310 further comprises a processing unit 316 controlling network address look up and translation.

FIG. 4 shows a schematic diagram of the method of fast look up and translation of network address and port in this embodiment of the invention. The host 300 in the external network transports a data packet 330 from port CP1 to port GP1 of NAPT gateway 310. The data packet 330 includes source IP address, source port information, destination address, and destination port information. The source IP address comprises the IP address C1 of the host 300, and the source port information comprises the port CP1 from which the host 300 connects to the NAPT gateway 310. The destination IP address comprises the public IP address G of NAPT gateway 310, and the destination port is the port GP1 of NAPT gateway 310 corresponding to port SP1 of server 320.

Normally, after receiving data packet 330 using transport-and-receiving unit 317, the NAPT gateway 310 searches NAPT translation table 314. If the corresponding translation data is not located in the NAPT translation table, the NAPT gateway 310 searches the virtual server mapping table 312. In this embodiment, data packet 330 is the first packet transported to port GP1 of NAPT gateway 310 by host 300, so virtual server mapping table 312 is searched for the related mapping data of the data packet 330. After searching and determining that the data packet 330 is to be transported to the port SP1 of the internal server the address of which is S1, the processing unit 316 acquires an unused entry of NAPT translation table 314 the index of which is I1 to store NAPT translation data. The NAPT translation data comprises private server IP address S1 and private server port information SP1, gateway IP address G and gateway port information GP1, host IP address C1 and host port information Cpl.

Next, the processing unit 316 translates the destination IP address and port information into private IP address S1 and port SP1 of server 320 and source port into a factor J1 related to the index I1 corresponding to the entry recording the translation data. Thus, the data packet 330 is translated into data packet 332. The factor J1 may be the index I1 or produced by adding index I1 to a constant, where the maximum value of the factor J1 is 2¹⁶−1. Finally, the transport-and-receiving unit 318 of the NAPT gateway 310 transports the data packet 332 to the real destination, i.e. server 320, according to the destination IP address.

In addition, the server 320 can return data packet 334 from port SP1 through NAPT gateway 310 to the host 300. The data packet 334 comprises source IP address, source port information, destination IP address, and destination port information. The source IP address and source port comprise IP address S1 and port SP1 of server 320, and the destination IP address and the destination port comprise IP address C1 of the host 300 and the factor J1 related to the index.

When NAPT gateway 310 receives the returned data packet 334 the factor J1 of which equals the index I1, the factor J1 is directly mapped to the translation data the index of which comprises I1 to perform NAPT. If factor J1 is produced by adding index I1 with a constant, when the index I1 is acquired by a simple operation, the index I1 is directly mapped to a translation data the index of which is I1 in the NAPT translation table 314 to perform NAPT. The translation data is acquired without hashing or linear searching, so time is saved, and the processing speed of the packet is enhanced. After acquiring the translation data, the NAPT gateway 310 performs a comparison to ensure that the acquired translation data is correct.

Next, the processing unit 316 replaces the source IP address and source port of data packet 334 respectively with G and GP1, comprising the public IP address of the NAPT gateway 310 and the port of the NAPT gateway 310 corresponding to the port SP1 of server 320 and the destination port with port CP1 of the host 300 recorded in the translation data. Thus, the data packet 334 is translated into data packet 336. Finally, the transport-and-receiving unit 317 of the NAPT gateway 310 transports the data packet 336 to host 300 according to the destination IP address therein.

Referring to FIG. 3, the host 302 in the external network can also transport a first data packet of a data stream from the port CP2 to the port GP2 of NAPT gateway 310. The first data packet comprises source IP address, source port information, destination IP address, and destination port information. After receiving the data packet, the NAPT gateway 310 searches the virtual server mapping table 312 according to the data packet, determining that the data packet is to be transferred to port SP2 of the server IP address of which is S2. Because the data packet is the first packet of the data stream, an unused entry with index I2 of NAPT translation table 314 is located and used to record the translation data comprising private IP address S2 and port information SP2 of the server 322, IP address G and port information GP2 of the gateway 310, and IP address C2 and port information CP2 of the host 302. In addition, host 304 in the external network can also transport a first data packet of a data stream from the port CP3 to the port GP1 of NAPT gateway 310. The first data packet includes source IP address, source port information, destination IP address, and destination port information. After receiving the data packet, the NAPT gateway 310 searches the virtual server mapping table 312 according to the data packet, determining that the data packet is to be transferred to port SP1 of the server the IP address of which is S1. Because the data packet is the first packet of the data stream, an unused entry with index I3 of NAPT translation table 314 is located and used to record the translation data including private IP address S1 and port information SP1 of the server 320, IP address G and port information GP1 of the gateway 310, and the IP address C3 and port information CP3 of the host 304. Next, the translation of the data packet, similar to that mentioned above, includes not only translating the destination IP address and destination port but also translating source port into a factor related to an index. Thus, when receiving the outgoing data packet from the internal (virtual) network, the NAPT gateway 310 of the invention can acquire the translation data by direct mapping and transport the outgoing data packet to external hosts 302 or 304.

In addition, when subsequent data packets of the same data flow are transported from the external network to the internal network, due to the translation data being recorded in the NAPT translation table 314, the NAPT gateway 310 of the invention searches the corresponding index using hashing, as with a general NAPT gateway. Next, the translation of the data packet, similar to the first data packet, comprises not only translating the destination IP address and destination port but also translating a source port into a factor related to an index. Thus, when receiving the returned packets from internal network to external network, the NAPT gateway 310 of the invention acquires the corresponding translation data of the returned data packets by direct mapping, translating and transporting the returned data packets.

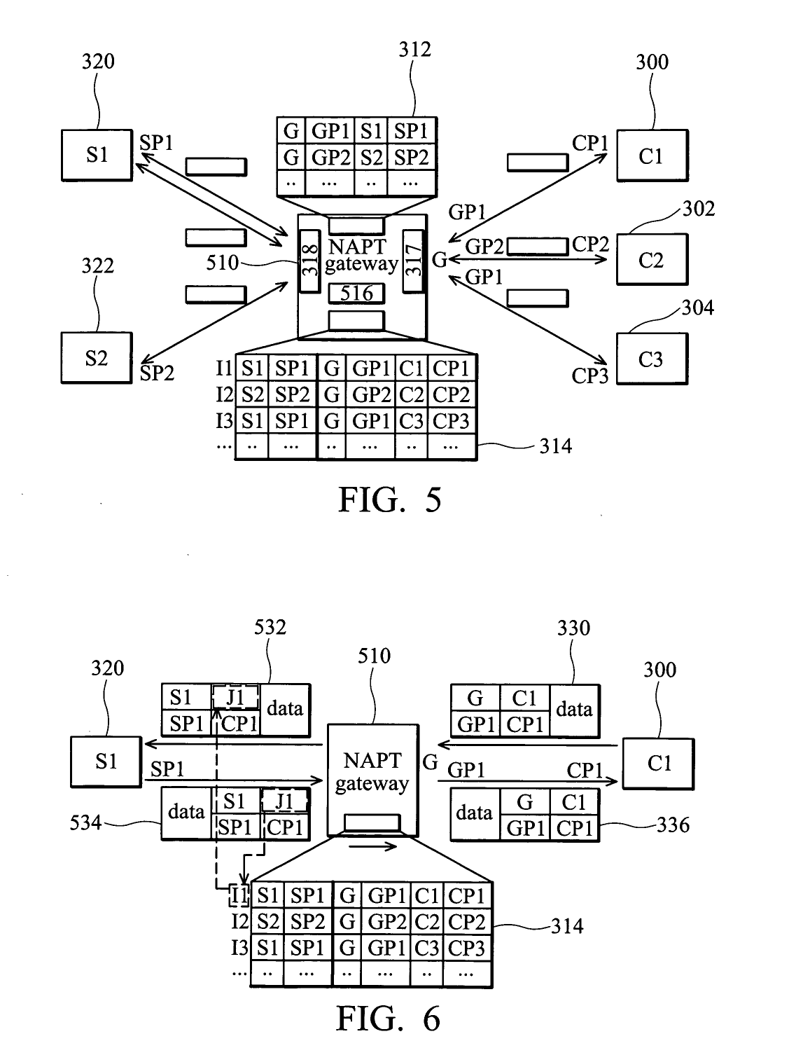

FIG. 5 is a structural diagram of the network address port translation (NAPT) gateway of the second embodiment of the invention. FIG. 5 is similar to FIG. 3 and is further characterized by the processing unit 516 which controls the network address and port look-up and translation using a different method. It should be noted that the elements in FIG. 3 and FIG. 5 performing the same functions are labeled with the same number.

FIG. 6 shows a schematic diagram of the method of fast look up and translation of network address and port in the second embodiment of the invention. The host 300 in the external network transports a data packet 330 from port CP1 to port GP1 of NAPT gateway 510. The data packet 330 comprises source IP address, source port information, destination address, and destination port information. The source IP address comprises IP address C1 of the host 300, and the source port information comprises port CP1 from which the host 300 connects to the NAPT gateway 510. The destination IP address is public IP address G of NAPT gateway 510, and the destination port is port GP1 of NAPT gateway 510 corresponding to port SP1 of server 320.

Normally, after receiving data packet 330 using transport-and-receiving unit 317, the NAPT gateway 510 searches NAPT translation table 314. If the corresponding translation data is not located in the NAPT translation table, the NAPT gateway 510 searches the virtual server mapping table 312. In this embodiment, data packet 330 is the first packet transported to port GP1 of NAPT gateway 510 by host 300, so virtual server mapping table 312 is searched for the related mapping data of the data packet 330. After searching and determining that the data packet 330 is to be transferred to the port SP1 of the internal server the address of which is S1, the processing unit 516 acquires an unused entry of NAPT translation table 314 the index of which is I1 to store NAPT translation data. The NAPT translation data include private server IP address S1 and private server port information SP1, gateway IP address G and gateway port information GP1, host IP address C1 and host port information CP1.

Next, the processing unit 516 translates the destination IP address and port information into private IP address S1 and port SP1 of server 320 and source IP address into a factor J1 related to the index I1 corresponding to the entry recording the translation data. Thus, the data packet 330 is translated into data packet 532. The factor J1 may be produced from index I1 logically operated with [10.0.0.0], wherein maximum value of the factor J1 is 2²⁴−1. The factor J1 may be produced from index I1 logically operated with [172.16.0.0], wherein maximum value of the factor J1 is 2²⁰−1. The factor J1 may be produced from index I1 logically operated with [192.168.0.0], wherein maximum value of the factor J1 is 2¹⁶−1. Finally, the transport-and-receiving unit 318 of the NAPT gateway 510 transports the data packet 532 to the real destination, i.e. server 320, according to destination IP address.

In addition, the server 320 can return data packet 534 from port SP1 through NAPT gateway 510 to the host 300. Because direct mapping in the method of the second embodiment depends on IP address, the method works even if the data packet 534 is IP fragmented. The data packet 534 comprising source IP address, source port information, destination IP address, and destination port information. The source IP address and source port comprise IP address S1 and port SP1 of server 320, and the destination IP address and the destination port comprise factor J1 related to the index and the port CP1 of the host 300.

When the index I1 is acquired from the factor J1 by a simple operation, the index I1 is directly mapped to a translation data the index of which is I1 in the NAPT translation table 314 to perform NAPT translation. The translation data is acquired without hashing or linear searching, so time is saved, and packet processing speed is enhanced. After acquiring the translation data, the NAPT gateway 510 performs comparison to ensure that the acquired translation data is correct.

Next, the processing unit 516 replaces the source IP address and source port of data packet 534 respectively with G and GP1, comprising the public IP address of the NAPT gateway 510 and the port of the NAPT gateway 510 corresponding to the port SP1 of server 320 and the destination IP address with the IP address C1 of the host 300 recorded in the translation data. Thus, the data packet 534 is translated into data packet 336. Finally, the transport-and-receiving unit 317 of the NAPT gateway 510 transports the data packet 336 to host 300 according to the destination IP address.

Referring to FIG. 5, the host 302 in the external network can also transport a first data packet of a data stream from the port CP2 to the port GP2 of NAPT gateway 510. The first data packet includes source IP address, source port information, destination IP address, and destination port information also. After receiving the data packet, the NAPT gateway 510 searches the virtual server mapping table 312 according to the data packet, determining that the data packet is to be transferred to port SP2 of the server the IP address of which is S2. Because the data packet is the first packet of the data stream, an unused entry with index I2 of NAPT translation table 314 is located and used to record the translation data including private IP address S2 and port information SP2 of the server 322, IP address G and port information GP2 of the gateway 510, and IP address C2 and port information CP2 of the host 302. In addition, host 304 in the external network can also transport a first data packet of a data stream from the port CP3 to the port GP1 of NAPT gateway 510. The first data packet comprises source IP address, source port information, destination IP address, and destination port information also. After receiving the data packet, the NAPT gateway 510 searches the virtual server mapping table 312 according to the data packet, determining that the data packet is to be transferred to port SP1 of the server the IP address of which is S1. Because the data packet is the first packet of the data stream, an unused entry with index I3 of NAPT translation table 314 is located and used to record the translation data including private IP address S1 and port information SP1 of the server 320, IP address G and port information GP1 of the gateway 510, and IP address C3 and port information CP3 of the host 304. Next, the translation of the data packet, similar to that mentioned above, not only translates the destination IP address and destination port but also source address into a factor related to an index. Thus, when receiving the outgoing data packet from the internal (virtual) network, the NAPT gateway 510 of the invention acquires the translation data by direct mapping and transports the outgoing data packet to external hosts 302 or 304.

In addition, when subsequent data packets of the same data stream are transported from the external network to the internal network, due to the translation data being recorded in the NAPT translation table 314, the NAPT gateway 510 of the invention searches the corresponding index using hashing, as with general NAPT gateways. Next, the translation of the data packet, similar to the first data packet, includes not only translating the destination IP address and destination port but also translating source address into a factor related to an index. Thus, when receiving the returned packets, by IP fragmented or not, from internal network to external network, the NAPT gateway 510 of the invention can acquire the corresponding translation data of the returned data packets by direct mapping, then translates and transports the returned data packets.

It should be noted that, in this embodiment, the NAPT gateways without load balance function are used as examples, although the method of network address fast look-up and translation of network address and port of the invention can also be implemented in a load balancing NAPT gateway.

To sum up, the method of network address port translation and fast look-up of the invention can be performed in a NAPT gateway. When the data packets are transported from an internal server to a NAPT gateway, the indices drawn from destination IP addresses or destination ports can be directly mapped to the translation data in the NAPT translation table without hashing or linear searching. Thus, the method of network address port translation and fast look-up of the invention enhances packet processing speed.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A method of network address port translation and fast look-up, implemented in a gateway connecting a virtual network and an external network, wherein the virtual network comprises at least a server, and the external network comprises at least a host, comprising the steps of:
creating a translation table including a plurality of translation data each provided with an index and comprising host address and port information, server address and port information, and gateway address and port information, the server address and port information comprising server internet protocol (IP) address and port information;
receiving, from the host, a first data packet comprising first source address and port information and first destination address and port information, wherein the first source address and port information comprise first source IP address and first source port information;
searching corresponding translation data of the first data packet in the translation table;
translating the first source IP address or port information into a factor related to the index of the translation data and the first destination address and port information into the server address and port information of the corresponding translation data when the corresponding translation data of the first data packet is located; and
transporting the first data packet to a corresponding server according to the server IP address therein.

2. The method as claimed in claim 1, further comprising the steps of:
receiving a second data packet comprising second source address and port information and second destination address and port information, wherein the second destination address and port information comprises second destination IP address and second destination port information, the second destination IP address or second destination port information is a second factor related to a second index;
acquiring the related second index according to the second factor and retrieving corresponding translation data of the second data packet from the translation table according to the second index directly;
translating the second source address and port information into gateway address and port information of the translation data and the second destination IP address or port information into host IP address or port information of the translation data; and
transporting the second data packet to a corresponding host according to the IP address of the corresponding host.

3. The method as claimed in claim 1, further comprising maintaining a mapping table in the gateway, storing a plurality of mapping data each comprising server address and port information and gateway address and port information.

4. The method as claimed in claim 3, further comprising the steps of:
searching related mapping data in the mapping table according to the first destination address and port information when corresponding translation data of the first data packet is not located in the translation table;
adding new translation data assigned with a third index in the translation table, which comprises the searched mapping data and the first source address and port information;
translating the first source IP address or port information into a factor related to the third index and first destination address and port information into server address and port information of the searched mapping data; and
transporting the first data packet to a corresponding server according to the IP address of the corresponding server.

5. A method of network address port translation and fast look-up, implemented in a gateway connecting a virtual internal network and an external network and comprising a mapping table, wherein the virtual internal network comprises at least a server, the external network comprises at least a host, and the mapping table stores private internet protocol (IP) address and private port information of each server, gateway IP address, and gateway port information, comprising the steps of:
creating a translation table comprising a plurality of translation data each provided with an index and containing host IP address, host port information, server private IP address, server private port information, gateway IP address, and gateway port information;
receiving, from the host, a first data packet comprising source IP address, source port information, destination IP address, and destination port information, wherein the source IP address and the source port information comprise an IP address and a port number of the host transporting the first data packet, and the destination IP address and the destination port information comprise an IP address and a port number of the gateway;
searching corresponding translation data of the first data packet in the translation table;
translating the source IP address or source port information into a factor related to the index of the translation data and the destination IP address and destination port information into the server private IP address and server private port information of the server when the corresponding translation data of the first data packet is located; and
transporting the first data packet to a corresponding server according to the translated destination IP address information therein.

6. The method as claimed in claim 5, further comprising the steps of:
receiving, from a server, a second data packet comprising a source IP address and source port information and a destination IP address and destination port information, wherein the source IP address and source port information comprise server private IP address and port information, the destination IP address comprises a host IP address, and the destination address or destination port information is a second factor related to a second index;
acquiring the related second index according to the second factor and retrieving corresponding translation data of the second data packet from the translation table according to the second index directly;
translating the destination IP address or destination port information into the host IP address or host port information of the host transporting the first data packet and the source IP address and source port information of the second data packet into a IP address and port information of the gateway; and
transporting the second data packet to the host according to the destination IP address.

7. The method as claimed in claim 5, further comprising the steps of:
searching a corresponding server private IP address and port information in the mapping table according to the destination IP address and port information when the corresponding translation data of the first data packet is not located in the translation table;
adding new translation data assigned with an index in the translation table, which comprises the searched private IP address, the searched port information, the source IP address, the source port information, the destination IP address, and the destination port information;
translating the source IP address or the source port information into a factor related to the corresponding index and the destination IP address and the destination port information into corresponding server private address and server port information of the searched mapping data; and
transporting the first data packet to a corresponding server according to the new destination IP address and destination port information.

8. A network address port translation (NAPT) gateway connecting a virtual network and an external network, comprising:
a translation table comprising a plurality of translation data each provided with an index and comprising host address and port information, server address and port information, and gateway address and port information, wherein the server address and port information comprising server internet protocol (IP) address information and port information;
a receiving unit receiving, from the host, a first data packet comprising first source address and port information and first destination address and port information, wherein the first source address and port information comprises first source IP address and first source port information;
a processing unit searching corresponding translation data of the first data packet in the translation table and translating the first source IP address or first source port information into a factor related to the index of the translation data and the first destination address and port information into the server address and port information of the corresponding translation data when the corresponding translation data of the first data packet is found; and
a transporting unit coupling with the processing unit and transporting the first data packet to a corresponding server according to the server IP address therein.

9. The gateway as claimed in claim 8, wherein the receiving unit receives, from a server, a second data packet comprising second source address and port information and second destination address and port information, wherein the second destination address and port information comprises second destination IP address and port information, and the second destination IP address or destination port information is a second factor related to a second index;

10. The gateway as claimed in claim 9, wherein the processing unit acquires the related second index according to the second factor and retrieves corresponding translation data of the second data packet from the translation table according to the second index directly and translating the second source address and port information into gateway address and port information of the translation data and the second destination IP address or destination port information into host IP address or port information of the translation data.

11. The gateway as claimed in claim 10, wherein the transporting unit transports the second data packet to a corresponding host according to the IP address thereof.

12. The gateway as claimed in claim 8, wherein the host address and port information comprises a host IP address and host port information, and the gateway address and port information comprises a gateway IP address and gateway port information.

13. The gateway as claimed in claim 8, further comprising:
a mapping table storing a plurality of mapping data each comprising server address and port information and gateway address and port information;
wherein the processing unit searches related mapping data according to the first destination address and port information, adding third translation data provided with a third index in the translation table, which comprises the searched mapping data and the first source address and port information, and translating the first source IP address or first source port information into a factor related to the third index when the corresponding translation data of the first data packet is not located.

14. The gateway as claimed in claim 13, wherein the server address and port information comprises a server IP address and server port information, and the gateway address and port information comprises a gateway IP address and gateway port information.
